(19) United States
(12) Patent Application Publication
(10) Pub. No.: US 2026/0206896 A1
(43) Pub. Date: Jul. 23, 2026

(54) THREE-DIMENSIONAL INSULATION REPLACEMENT

(71) Applicant: The North Face Apparel Corp., Wilmington, DE (US)

(72) Inventors: Stephen Lewandowski, Morrison, CO (US); Forrest Cannon, Wheat Ridge, CO (US); Alford Lee, Denver, CO (US); Mackenzie Leighton, Denver, CO (US); Isaac Oaks, Carbondale, CO (US); Jane Bixby Love, Northglenn, CO (US); Cory Olson, Morrison, CO (US); Kyle Watson, Denver, CO (US)

(21) Appl. No.: 19/451,954

(22) Filed: Jan. 16, 2026

Related U.S. Application Data
(60) Provisional application No. 63/746,521, filed on Jan. 17, 2025.

(51) Int. Cl. A41D 31/06

(52) U.S. Cl. CPC A41D 31/06

(57) ABSTRACT

The present disclosure describes an insulative baffle comprising a shell material and a liner material are spaced apart to define a baffle cavity. The cavity is populated with a plurality of three-dimensional (3D) insulative structures. Each 3D structure is formed as a unitary frame made up of multiple interconnected struts. The arrangement of these struts defines apertures between them, and the frame collectively encloses an internal cavity. Because each 3D structure is a discrete, resilient body, the plurality of such structures provides structural support that maintains separation between the shell and liner materials and allows the baffle to loft and recover after compression. At the same time, the shape, distribution, and hollow nature of these frames trap air and impede heat transfer, so the 3D structures not only hold the baffle open but also actively contribute to the insulative performance of the baffle without relying on loose fibers or down.

### CROSS-REFERENCE TO RELATED APPLICATION

This application is a Nonprovisional of and claims the benefit of Provisional Application Serial Number 63/746,521, filed January 17, 2025, which is hereby incorporated by reference in its entirety for any and all purposes.

### BACKGROUND

Traditionally, feathers have been used to provide insulation in material. However, feathers may poke through the material, causing injury or a loss of insulation.

However, improvements are needed.

### SUMMARY

The following summary is for illustrative purposes only and is not intended to limit or constrain the detailed description.

The present disclosure describes an insulative baffle in which a shell material (e.g., face fabric) and a liner material (e.g., backer) are spaced apart to define a baffle cavity, and that cavity is populated with a plurality of engineered three-dimensional (3D) insulative structures. Each 3D structure is formed as a unitary frame made up of multiple interconnected struts. The arrangement of these struts defines apertures between them, and the frame collectively encloses an internal cavity. Because each 3D structure is a discrete, resilient body, the plurality of such structures provides structural support that maintains separation between the face and backer materials and allows the baffle to loft and recover after compression. At the same time, the shape, distribution, and hollow nature of these frames trap air and impede heat transfer, so the 3D structures not only hold the baffle open but also actively contribute to the insulative performance of the baffle without relying on loose fibers or down.

The present disclosure describes an individual insulative three-dimensional structure as a standalone component. This structure is defined by a network of interconnected struts that form a continuous frame with multiple apertures between the struts, and a cavity enclosed within the frame. The frame is manufactured as a unitary body, so the entire element behaves as a single spring-like member that can flex and recover without coming apart. When incorporated into a baffle, this individual 3D structure acts as a modular building block that both supports the surrounding layers by providing resilient spacing and contributes to thermal insulation by trapping air within and around its apertured, hollow geometry. Thus, the claimed 3D structure is expressly configured to enhance both the structural resilience and the insulating quality of any baffle in which it is used.

The present disclosure describes an insulative article, such as a garment or sleeping bag, that includes a shell material and a liner material spaced apart to define one or more baffles. Within at least one baffle lies a sheet composed of multiple insulative 3D structures that are interconnected by interconnecting struts. At locations between neighboring 3D structures, at least two of these interconnecting struts meet or are integral with one another to form connector regions. The sheet is secured to the shell material, the liner material, or both, at these connector regions, rather than directly at the 3D structures themselves. As a result, the majority of the 3D structures may remain free of direct attachment to the textile layers. This arrangement stabilizes the sheet within the baffle while preserving the loft, compressibility, and flexibility of the interconnected 3D structures, allowing the article to remain comfortable, resilient, and thermally effective even as it is worn, packed, or otherwise compressed in use.

These and other features and advantages are described in greater detail below.

### BRIEF DESCRIPTION OF THE DRAWINGS

The present disclosure is pointed out with particularity in the appended claims. However, other features of the present disclosure will become more apparent, and the present disclosure will be best understood by referring to the following detailed description in conjunction with the accompany drawings in which:

FIGS. 1A-1B show example insulative items described herein;

FIG. 2 shows an example insulative three-dimensional (3D) structure described herein;

FIG. 3 shows an example insulative 3D structure described herein;

FIG. 4 shows an example insulative 3D structure described herein;

FIG. 5 shows an example insulative 3D structure described herein;

FIG. 6 shows an example of a sheet of insulative 3D structures described herein;

FIG. 7 shows an example of a sheet of insulative 3D structures described herein;

FIG. 8 shows an example insulative 3D structure described herein; and

FIG. 9 shows an example of a sheet of insulative three-dimensional (3D) structures described herein.

The accompanying drawings show examples of the disclosure. It is to be understood that the examples shown in the drawings and/or discussed herein are non-exclusive and that there are other examples of how the disclosure may be practiced.

### DETAILED DESCRIPTION

The present disclosure generally relates to an insulation replacement.

The three-dimensional (3D) material described herein may be soft and flexible. The 3D material described herein may be configured to have sufficient rigidity such that the 3D material may bounce back to an original shape after compression.

The 3D material described herein may be 3D printed. The 3D material may comprise connecting struts forming a hollow spherical structure. A plurality of the 3D material described herein may be disposed in a cavity created by a face (e.g., outer shell) of an item and a liner of the item. The plurality of the 3D material may be loose fill or may be linked or otherwise coupled to each other in groupings, patterns, baffle structures, or the like. Other forms, shapes, and groupings of 3D material may be used. The plurality of the 3D material may provide loft to the cavity created by the face and the liner of the item. Fabric associated with the face of the item may comprise an air permeability of under 30 cubic feet per minute (cfm) using ASTM D737. Other air permeability may be used such as under 250 CFM, or between 0.1 and 50 CFM. Certain down-proof materials typically have a CFM limit of 1 CFM. As such, the present shell or liner materials may have a CFM higher than 1 CFM, or between 1 and 250, or between 1 and 50 CFM using ASTM D737. The item may be any item comprising loose fill insulation, such as a jacket, sleeping bag, etc. The present disclosure may achieve desirable thermal retention with higher cfm fabrics, which are not be limited to down-proof fabric.

The 3D material described herein may be compressible. The 3D material described herein may be lightweight. The 3D material described herein may allow for use of fabrics with a higher cfm than fabrics that use other insulation material, such as feathers or fiber.

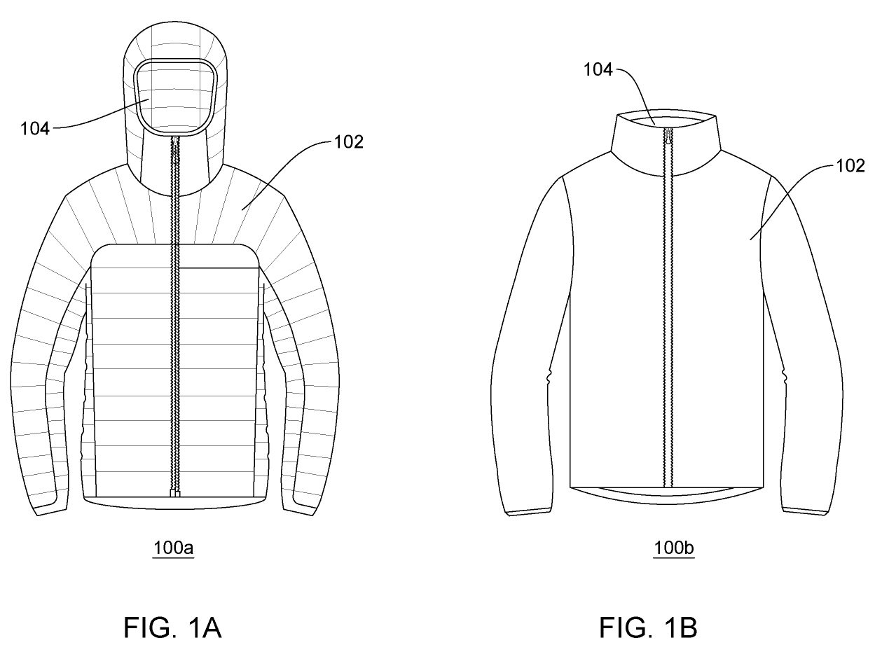

FIG. 1 show example insulative items 100a and 100b described herein. Although the items 100a and 100b shown are jackets, any item with an insulative baffle may be used, such as a sleeping bag, a ski bib, mittens, gloves, goalie equipment, such as pants, gloves, etc. The insulative items 100a and 100b may comprise a face material or shell material 102. The shell material 102 may be configured to comprise at least part of an exterior of the insulative items 100a and 100b when in use. The shell material 102 may comprise a fabric comprising an air permeability of under 30 cubic feet per minute (cfm) using ASTM D737 or other acceptable standard. Other permeability may be used. The shell material 102 may form a shell of the insulative items 100a and 100b. The shell material 102 may comprise knit fabric. The shell material 102 may comprise woven fabric. The shell material 102 may comprise fabric configured to be stretched. The shell material 102 may comprise fabric configured not to be stretched.

The insulative items 100a and 100b may comprise a backer or liner material 104. The liner material 104 may be configured to comprise at least part of an exterior of the insulative items 100a and 100b when in use. The liner material 104 may be configured to be disposed adjacent skin of a user (wearer, etc.) of the insulative items 100a and 100b. The shell material 102 and the liner material 104 may define a cavity. The cavity may be disposed between the shell material 102 and the liner material 104. The cavity may be configured to comprise a plurality of insulative three-dimensional (3D) material disposed therein. The plurality of insulative 3D material may replace other insulation, such as feathers, fibers, etc. The plurality of insulative 3D material may provide resilient structure to the cavity. The insulative 3D material will be described in the following figures. The liner material 104 may comprise knit fabric. The liner material 104 may comprise woven fabric. The liner material 104 may comprise fabric configured to be stretched. The liner material 104 may comprise fabric configured not to be stretched. The liner material 104 may comprise a fabric comprising an air permeability higher than an air permeability associated with a fabric associated with the shell material 102. Configurations may be used with a shell material or face material, but without the backer or liner. References made to a face or backer, or a shell or liner are used as illustrative examples. Configurations may include one or more sheets of material disposed adjacent the 3D structures without departing from the spirit of the disclosure.

The shell material 102 may comprise a fabric having an air permeability in a range from about 0.1 cubic feet per minute (cfm) to about 250 cfm, as measured in accordance with applicable or standard textile air-permeability test methods. Improved thermal retention may be achieved when the shell material 102 has an air permeability in a lower range, for example from about 0.1 cfm to about 50 cfm (including intervening endpoints), which may provide particularly favorable thermal retention properties. However, the use of the insulative three-dimensional (3D) structures described herein may allow shell materials 102 with significantly higher air permeabilities—such as greater than 50 cfm, greater than 100 cfm, or up to about 250 cfm—to be employed while still maintaining desired thermal insulation performance.

When conventional natural or synthetic loose-fill insulation is used, the air permeability of the face fabric is often limited by the need to prevent fiber or feather migration through the face fabric. For example, face fabrics for down-filled garments may be selected to have relatively low cfm values (often under about 30 cfm) to reduce the likelihood that feather quills or individual fibers will protrude through and escape the baffles. In contrast, the insulative 3D structures disclosed herein may be configured as discrete, unitary polymeric or 3D-printed bodies having rigid or semi-rigid frames and defined apertures rather than as collections of loose fibers. As a result, there is substantially no concern regarding fiber migration or feather “poking” through the shell material 102, and the insulative items 100a, 100b can utilize face fabrics with higher air permeability than would otherwise be practical with conventional feather or fiber-based insulation.

The ability to use higher-cfm face fabrics in combination with the 3D insulative structures provides several advantages. Higher-permeability face fabrics may improve breathability and moisture management (for example, by increasing moisture vapor transmission) while maintaining loft and thermal retention. Because the structural integrity of the 3D insulative elements substantially prevents migration of the insulative material through the face fabric across a broad range of air-permeability values, designers are freed from the traditional requirement of low-permeability shells. The 3D structures thus enable optimization of the balance between thermal insulation, air permeability, breathability, and comfort in insulative items, in ways not readily achievable with conventional feather or synthetic staple-fiber insulations.

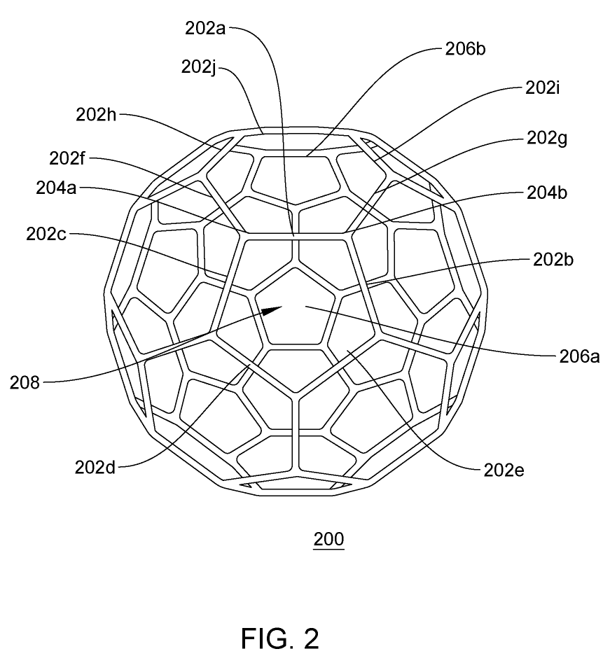

FIG. 2 shows an example insulative three-dimensional (3D) structure 200 described herein. As shown, the example insulative 3D structure 200 may comprise a plurality of struts, such as struts 202a-202j. The struts may connect at connection points. For example, struts 202a, 202c, and 202f connect at connection point 204a. As another example, struts 202a, 202b, and 202g connect at connection point 202b. The struts may connect to form an aperture. For example, struts 202a-202e connect to form aperture 206a. As another example, struts 202a and 202f-202j connect to form aperture 206b. The struts may surround a cavity 208 of the example insulative 3D structure 200.

The struts may comprise a polymer. The struts may be compressible. The struts may be resilient, such that a shape is maintained after compression. The struts may be 3D printed. The struts may form a unitary body.

The connection points may comprise a connection of two or more struts. Each strut connected to a connection point may help define an aperture. In an embodiment, such as the insulative 3D structure 200, each connection point may comprise exactly three struts. In another embodiment, discussed in more detail below, some struts that would help define an aperture are absent (removed, not included, etc.) such that some connection points comprise two struts. The connection points may comprise rounded edges. Rounded edges may improve hand feel.

The apertures may form shapes. For example, aperture 206a may form a pentagon. As another example, aperture 206b may form a hexagon. Any other shape is contemplated. Connected struts forming the apertures may form a surface of the example insulative 3D structure 200. In another embodiment, discussed in more detail below, some struts that would help define an aperture are absent (removed, not included, etc.) such that some connection points comprise two struts. For example, strut 202a may be missing. However, even in the absence of strut 202a, connection points 204a and 204b imply that strut 202a could form a boundary for aperture 206a and 206b. Therefore, apertures may be defined by a combination of struts and implied lines between connection points. The apertures may be planar. The apertures may be spherical. Planar and/or spherical apertures may improve hand feel.

The cavity 208 of the insulative 3D structure 200 may allow the insulative 3D structure 200 to be compressed. The cavity 208 of the insulative 3D structure 200 may help a baffle of an item comprising the insulative 3D structure 200 to maintain a fluffy (round, curvy, textured, non-flat, etc.) attribute.

An insulative 3D structure, as described herein, may comprise a diameter, as defined by a longest distance between points where struts connect. An insulative 3D structure, as described herein, may comprise a diameter, as defined by a longest distance between points on struts. The insulative 3D structure 200 may comprise a diameter of 26 millimeters or less. The insulative 3D structure 200 may comprise a diameter of 19 millimeters or less. The insulative 3D structure 200 may comprise a diameter of 2 inches or less. The insulative 3D structure 200 may comprise a diameter of 0.75 inches or less. The insulative 3D structure 200 may comprise a diameter of 0.625 inches or less. The insulative 3D structure 200 may comprise a diameter of 0.5 inches or less. The struts of the example insulative 3D structure 200 may comprise a thickness of 2 millimeters or less. The struts of the example insulative 3D structure 200 may comprise a thickness of 1 millimeter or less. The struts of the example insulative 3D structure 200 may comprise a thickness of 0.8 millimeters or less. The struts of the example insulative 3D structure 200 may comprise a thickness of 0.7 millimeters or less. The struts of the example insulative 3D structure 200 may comprise a thickness of 0.6 millimeters or less.

An insulative 3D structure, as described herein, may comprise twenty hexagonal-shaped apertures. An insulative 3D structure, as described herein, may comprise twelve pentagonal-shaped apertures. An insulative 3D structure, as described herein, may comprise sixty points where struts connect. An insulative 3D structure, as described herein, may comprise twenty points where struts connect. An insulative 3D structure, as described herein, may comprise an icosahedron shape. An insulative 3D structure, as described herein, may comprise a pentagonal dodecahedron shape. An insulative 3D structure, as described herein, may comprise a truncated icosahedron shape. An insulative 3D structure, as described herein, may comprise a buckminsterfullerene shape. An insulative 3D structure, as described herein, may comprise carbon.

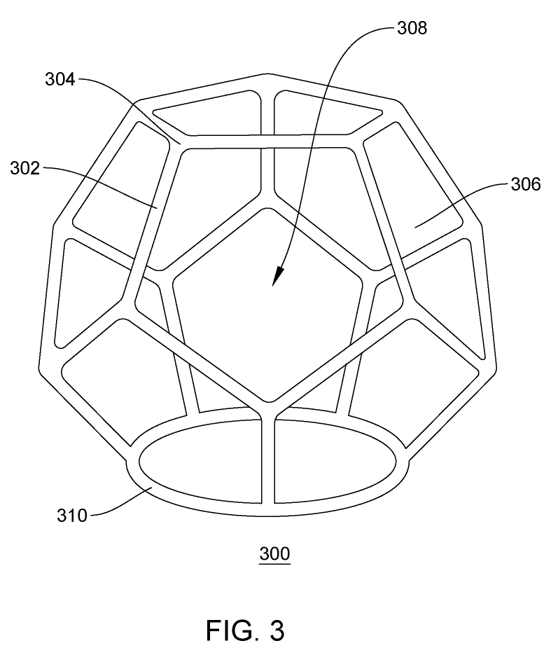

FIG. 3 shows an example insulative three-dimensional (3D) structure 300 described herein. The example insulative 3D structure 300 may comprise struts, such as strut 302, connection points, such as connection point 304, apertures, such as aperture 306, and a cavity 308. The struts may be similar to the struts discussed in FIG. 2. The connection points may be similar to the connection points discussed in FIG. 2. The apertures may be similar to the connection points discussed in FIG. 2. The cavity 308 may be similar to the cavity 208 discussed in FIG. 2.

The example insulative 3D structure 300 may comprise a planar shape 310. The planar shape 310 may allow the example insulative 3D structure 300 to be disposed stationary on a flat surface. The planar shape 310 may comprise a round shape or partial shape, such as a circle, semi-circle, arc, oval, etc. The planar shape 310 may comprise any two-dimensional (2D) geometric shape or partial shape, including a triangle, quadrilateral, pentagon, hexagon, etc. Aside from the planar shape 310 of the example insulative 3D structure 300, the remainder of the example insulative 3D structure 300 may comprise one or more planar (e.g., flat) regions and/or spherical (e.g., rounded) regions.

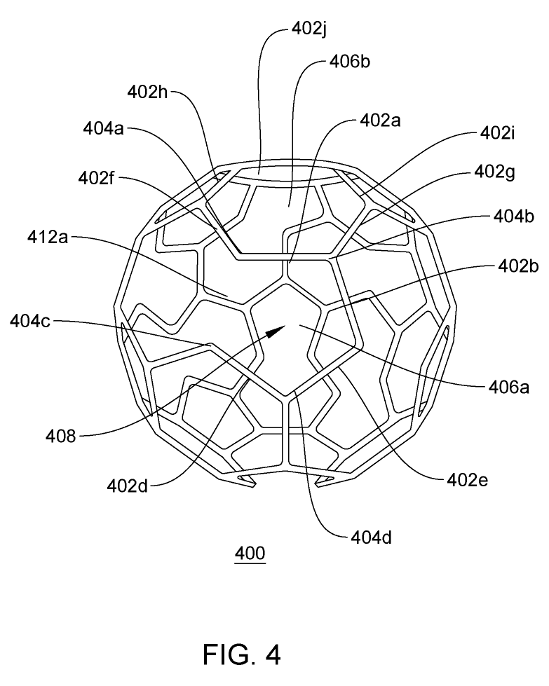

FIG. 4 shows an example insulative three-dimensional (3D) structure 400 described herein. The example insulative 3D structure 400 comprises struts, such as struts 402a, 402b, and 402d-402j, connection points, such as connection points 404a-404d, apertures, such as apertures 406a and 406b, and cavity 408. The struts may be similar to the struts discussed in FIG. 2. The connection points may be similar to the connection points discussed in FIG. 2. The apertures may be similar to the connection points discussed in FIG. 2. The cavity 408 may be similar to the cavity 208 discussed in FIG. 2.

The example insulative 3D structure 400 may be similar to the example insulative 3D structure 200 discussed in FIG. 2, except that some struts are absent (removed, not included, etc.). For example, a strut connecting connection point 404a and connection point 404c is absent. Instead, aperture 406a is defined by struts 402a, 402b, 402d, 402e, and an implied line 412a between connection point 404a and connection point 404c. A strut may be linear, wherein a distinct vertex is visible at a connection point. A strut may be smoother where a connection point is less noticeable due to a filleting of the strut and/or a smoother and/or rounded connection at the connection point. As an example, struts may be spaced further apart, decreasing material per volume/area and thereby decreasing final compressible volume. Other arrangements may be used.

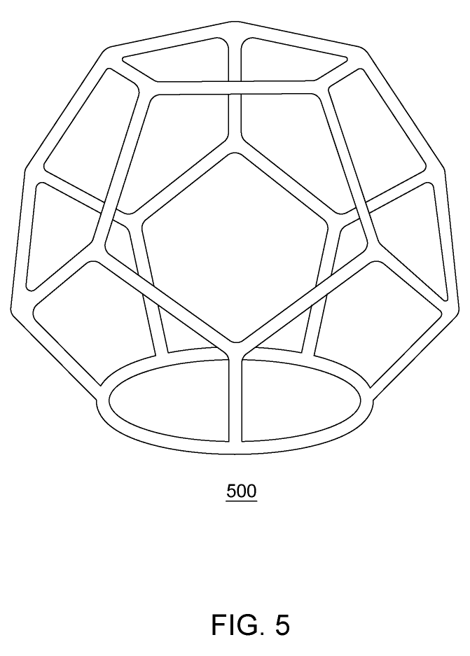

FIG. 5 shows an example insulative three-dimensional (3D) structure 500 described herein. The example insulative 3D structure 500 may comprise struts, connection points, apertures, and a cavity. The struts may be similar to the struts discussed in FIG. 2. The connection points may be similar to the connection points discussed in FIG. 2. The apertures may be similar to the connection points discussed in FIG. 2. The cavity may be similar to the cavity 208 discussed in FIG. 2.

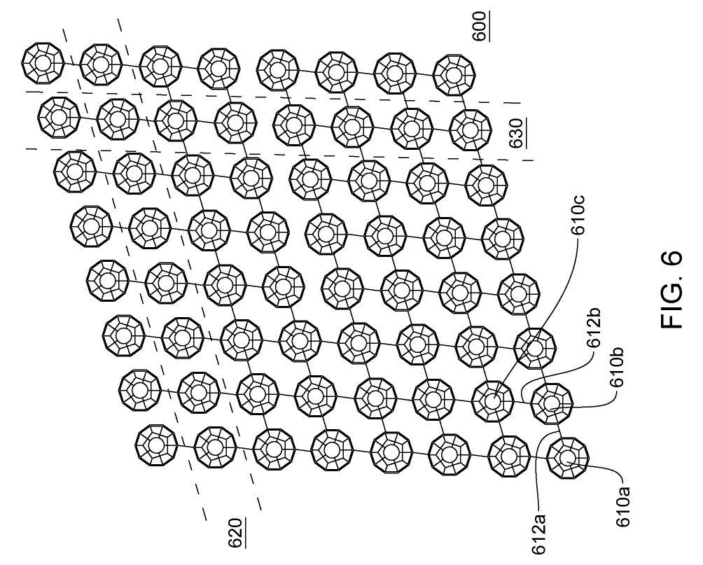

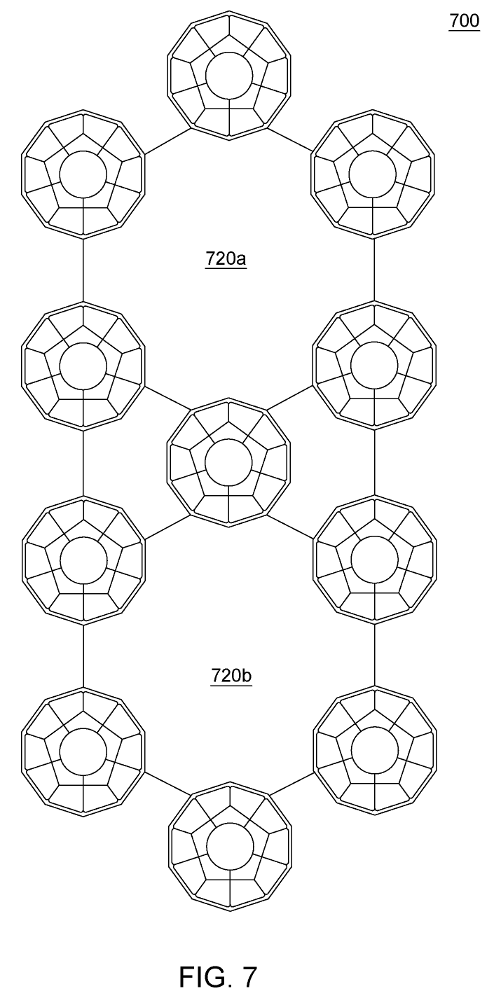

FIGS. 6 and 7 shows example sheets 600, 700 of insulative three-dimensional (3D) structures described herein. As shown, the example insulative 3D structures may be connected via struts. For example, example insulative 3D structure 610a may be connected to example insulative 3D structure 610b via strut 612a. As another example, the example insulative 3D structure 610b may be connected to example insulative 3D structure 610c via strut 612b. The example insulative 3D structures 610 be similar to the insulative 3D structures previously discussed. The example insulative 3D structures may be arranged in an organized manner, such as in rows, such as row 620, and columns, such as column 630 of example sheet 600. The example insulative 3D structures may be arranged in a grid, such as the 8x8 grid the example insulative 3D structures 610 are arranged in in example sheet 600. The example insulative 3D structures may be arranged more randomly. Spacing and locations of various components may be adjusted.

The struts 612 between the example insulative 3D structures 610 may be configured to be parallel to the ground. The struts 612 between the example insulative 3D structures 610 may be configured to be angled relative to the ground. The struts 612 between the example insulative 3D structures 610 may be configured to be 1 millimeter or longer. The struts 612 between the example insulative 3D structures 610 may be configured to be 10 millimeters or shorter. Connecting the example insulative 3D structures 610 with the struts 612 may spread the example insulative 3D structures 610 out. Connecting the example insulative 3D structures 610 with the struts 612 may decrease weight. Connecting the example insulative 3D structures 610 with the struts 612 may increase compressibility. Connecting the example insulative 3D structures 610 with the struts 612 may stabilize the example insulative 3D structures 610. Connecting the example insulative 3D structures 610 with the struts 612 may allow the example insulative 3D structures 610 to mimic sheet insulation. Shapes and connections of struts may be varied. Various curvatures, patterns, and features of the struts and interconnects may be used.

In an aspect, the shell material and the liner material may be bonded together in areas between the example insulative 3D structures 610. For example, turning briefly to FIG. 7, example sheet 700 may comprise a first gap 720a and a second gap 720b. An associated shell material and liner material may be bonded together at the first gap 720a and/or at the second gap 720b.

In an aspect, multiple layers of example insulative 3D structures 610 may be disposed proximate to each other. In a first configuration, the sheets 600, 700 may be configured such that the example insulative 3D structures 610 of a first layer of sheets are disposed directly proximate to the example insulative 3D structures 610 of a second layer of sheets. In a second configuration, the sheets 600, 700 may be configured such that the example insulative 3D structures 610 of a first layer of sheets are disposed in spaces in between the example insulative 3D structures 610 of a second layer of sheets. The first configuration may be thicker than the second configuration. The second configuration may be firmer than the first configuration. A strut in the first configuration connecting the first layer with the second layer may be 1 millimeter or greater. A strut in the first configuration connecting the first layer with the second layer may be 4 millimeters or less. A strut in the second configuration may connect the first layer and the second layer at 1 millimeter (or less) below the top of an example insulative 3D structure 610 of the first layer and/or the second layer. A strut in the second configuration may connect the first layer and the second layer at the top of an example insulative 3D structure 610 of the first layer and/or the second layer. A strut in the second configuration may connect the first layer and the second layer at 4 millimeter (or less) above the top of an example insulative 3D structure 610 of the first layer and/or the second layer.

The sheets 600, 700 of interconnected insulative 3D structures may be coupled to one or both of the shell material 102 and the liner material 104 in a variety of ways. The sheets 600, 700 may be stitched or sewn to an underlying textile substrate along one or more attachment lines that pass through relatively flat or planar regions of the sheet, such as gaps between adjacent insulative 3D structures 610, planar regions formed between the 3D structures, intersections of interconnecting struts 612, or specially provided attachment tabs. The attachment lines may extend continuously or discontinuously across the sheet to stabilize its position within a baffle while accommodating flexing and drape of the finished item.

The sheets 600, 700 may be bonded, ultrasonically welded, adhesively attached, or otherwise secured to the shell material 102 and/or the liner material 104. For example, a hot-melt adhesive, film adhesive, or curable adhesive may be applied at selected planar regions or tabs of the sheets 600, 700 to bond the sheets to the adjacent textile layers. Ultrasonic welding or other thermal welding processes may be used where the polymer of the insulative 3D structures and the textile substrates are compatible thermoplastic materials. Mechanical attachment methods, such as snaps, rivets, or other fasteners, may also be used alone or in combination with sewing or bonding. The choice of attachment method, and of the particular portions of the sheet used for attachment, may depend on the construction of the insulative item 100a, 100b, the composition of the polymer used to form the insulative 3D structures, and the desired properties of the final insulative item, including durability, flexibility, drape, compressibility, and hand feel.

Attachment of the sheets 600, 700 to the shell material 102 and/or the liner material 104 is localized primarily to relatively flat portions of the sheets. For instance, attachment may be made at generally disk-shaped, tab-like, or locally planar regions located between adjacent insulative 3D structures 610 or at intersections of the interconnecting struts 612, while leaving the majority of each individual insulative 3D structure 610 free to expand, compress, and recover within the baffle cavity. Localizing attachment to such planar regions can stabilize the position and distribution of the sheets 600, 700 relative to the surrounding fabrics and maintain even coverage of the insulative structures, while reducing stress concentrations at the attachment points and preserving the loft, resilience, flexibility, and comfort of the insulation assembly.

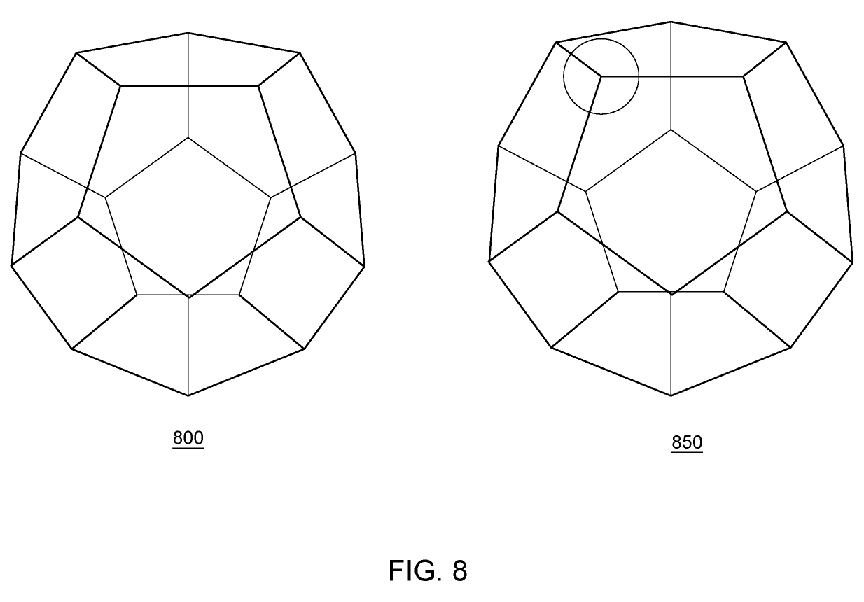

FIG. 8 illustrates additional examples forms of the structures 800, 850. As shown, the interconnects on structure 850 includes additional material. Other shapes, forms and features may be used.

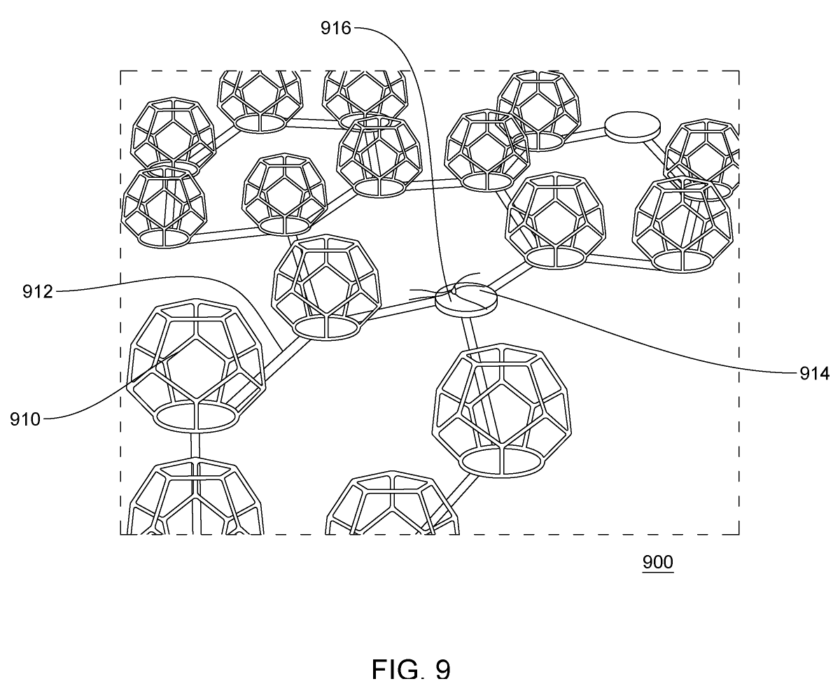

FIG. 9 illustrates an example sheet 900 of interconnected insulative three-dimensional (3D) structures according to certain embodiments. As shown, the sheet 900 includes a plurality of insulative 3D structures 910 arranged in a repeating pattern and interconnected by a network of generally linear interconnecting struts 912. The insulative 3D structures 910 may be similar to any of the insulative 3D structures described herein (for example, structures 200, 300, 400, 610) and may be distributed in one or two dimensions across the sheet 900. The interconnecting struts 912 maintain a desired spacing and positional relationship between adjacent insulative 3D structures 910 while allowing the sheet 900 to flex and conform to curved or contoured regions of the insulative item 100a, 100b, and to compress and decompress during use. The interconnecting struts 912 may be similar to the interconnecting struts 612 discussed above.

In the embodiment shown in FIG. 9, the interconnecting struts 912 join at, or are associated with, a plurality of generally planar connector regions 914 distributed across the sheet 900. Each connector region 914 may be formed as a disk-like, tab-like, or otherwise substantially planar area that is integral with one or more of the interconnecting struts 912 and positioned between adjacent insulative 3D structures 910. These connector regions 914 provide localized, relatively flat surfaces suitable for attaching the sheet 900 to a textile substrate such as the shell material 102 and/or the liner material 104. The 3D structures 910 may have a planar shape, similar to the planar shape 310 in 3D structure 300. The generally planar connector regions 914 and the planar shape of the 3D structures 910 may be on a same plane.

In one example configuration, a line of stitching 916 (for example, a thread or yarn) passes through each connector region 914 and through a corresponding portion of the shell material 102, the liner material 104, or both, thereby securing the sheet 900 in place within a baffle. Because the connector regions 914 are substantially planar and may present increased surface area compared to the struts 912, sewing through these regions may reduce stress concentrations, minimize damage to the surrounding 3D structures 910, and facilitate reliable attachment using conventional garment-manufacturing equipment. Moreover, because attachment is made at discrete connector regions 914 located between adjacent insulative 3D structures 910, the spherical, rounded, or otherwise three-dimensional portions of the insulative 3D structures 910 remain largely unconstrained, thereby maintaining loft, compressibility, and flexibility of the baffle and improving comfort.

Although FIG. 9 depicts sewing through the connector regions 914 using threads 916, any of the attachment techniques described herein may be used at these or similar planar attachment sites. For example, the connector regions 914 may be bonded or welded to the shell material 102 or liner material 104 using adhesive bonding, thermal bonding, or ultrasonic welding, or may be mechanically fastened using snaps, rivets, or other fasteners. The connector regions 914 may include through-holes, surface texturing, or other features configured to enhance mechanical interlock or bonding strength with surrounding textile or adhesive materials. The number, pattern, and spacing of the attachment points at connector regions 914 may be selected to ensure stability and even distribution of the insulative 3D structures 910 across the fabric while allowing the structures 910 to compress and expand during use without excessive stress at any single attachment point. By spacing the connector regions 914 along the sheet 900 and limiting attachment to these discrete locations, the sheet 900 can be securely anchored within the baffle cavity while still allowing controlled drape and articulation of the assembly, reducing a stiff or “boardy” feel and preventing substantial migration or bunching of the sheet 900.

As schematically illustrated in FIG. 9, the sheet 900 of insulative 3D structures 910 may be attached to an adjacent shell material 102 or liner material 104 at multiple connector regions 914 distributed across the area of the sheet. The sewn or bonded attachments at these flat areas between structures may secure the sheet 900 to the fabric substrate while leaving portions of the 3D structures 910 unsecured, thereby maintaining compressibility and flexibility of the insulation. The attachment points may be arranged to correspond to quilting lines or baffle boundaries in the shell material 102 and/or liner material 104, integrating structural attachment of the sheet 900 with the aesthetic and functional seaming of the insulative item and promoting uniform distribution of the insulative 3D structures across the garment or article. Such configuration may provide desirable packability of the 3D structures and compressibility of the 3D form. Such configuration may maintain a smooth engagement with the shell material 102 or liner material 104 without undesirable bunching or rotation of the 3D structures. Such configurations may allow for more air permeable materials without sacrificing desirable thermal properties achieved through the trapping of air by the structures. As an example, face/liner materials may be selected from non down-proof materials.

Example Clause 1: An insulative baffle comprising: a shell material; a backer material, wherein the shell material and the backer material define a baffle cavity therebetween; and a plurality of insulative three-dimensional (3D) structures disposed in the baffle cavity, wherein the plurality of insulative 3D structures comprise a plurality of interconnected struts defining a frame of each of the plurality of insulative 3D structures, wherein a plurality of apertures are further defined between the plurality of interconnected struts, wherein the frame forms a unitary body that defines a cavity within the frame, wherein the plurality of insulative 3D structures are configured to provide resilient structure to the insulative baffle, and wherein the plurality of insulative 3D structures are configured to facilitate an insulative quality of the insulative baffle.

Example Clause 2: The insulative baffle of Example Clause 1, wherein each of the plurality of apertures comprise a shape based on the plurality of interconnected struts defining an associated aperture, and wherein each of the shapes is either a hexagonal shape or a pentagonal shape.

Example Clause 3: The insulative baffle of Example Clause 1 or Example Clause 2, wherein each of the plurality of insulative 3D structures comprise twenty hexagonal-shaped apertures, and wherein each of the plurality of insulative 3D structures comprise twelve pentagonal-shaped apertures.

Example Clause 4: The insulative baffle of any one of Example Clauses 1-3, wherein at least one side of at least one shape is defined by a space between interconnecting struts.

Example Clause 5: The insulative baffle of any one of Example Clauses 1-4, wherein at least one aperture of each of the plurality of insulative 3D structures comprise a planar shape.

Example Clause 6: The insulative baffle of any one of Example Clauses 1-5, wherein the planar shape comprises a circle.

Example Clause 7: The insulative baffle of any one of Example Clauses 1-6, wherein the planar shape comprises a semi-circle.

Example Clause 8: The insulative baffle of any one of Example Clauses 1-7, wherein the planar shape comprises an oval.

Example Clause 9: The insulative baffle of any one of Example Clauses 1-8, wherein the planar shape comprises an arc.

Example Clause 10: The insulative baffle of any one of Example Clauses 1-9, wherein the plurality of interconnected struts on each insulative 3D structure comprises sixty points where struts connect.

Example Clause 11: The insulative baffle of any one of Example Clauses 1-10, wherein the plurality of interconnected struts on each insulative 3D structure comprises twenty points where struts connect.

Example Clause 12: The insulative baffle of any one of Example Clauses 1-11, wherein each of the plurality of insulative 3D structures comprise a diameter, wherein the diameter of a particular insulative 3D structure is defined by a longest distance between points on the particular insulative 3D structure where struts connect.

Example Clause 13: The insulative baffle of any one of Example Clauses 1-12, wherein the diameters of the plurality of insulative 3D structures are 26 millimeters or less.

Example Clause 14: The insulative baffle of any one of Example Clauses 1-13, wherein the diameters of the plurality of insulative 3D structures are 19 millimeters or less.

Example Clause 15: The insulative baffle of any one of Example Clauses 1-14, wherein the diameters of the plurality of insulative 3D structures are 2 inches or less.

Example Clause 16: The insulative baffle of any one of Example Clauses 1-15, wherein the diameters of the plurality of insulative 3D structures are 0.75 inches or less.

Example Clause 17: The insulative baffle of any one of Example Clauses 1-16, wherein the diameters of the plurality of insulative 3D structures are 0.625 inches or less.

Example Clause 18: The insulative baffle of any one of Example Clauses 1-17, wherein the diameters of the plurality of insulative 3D structures are 0.5 inches or less.

Example Clause 19: The insulative baffle of any one of Example Clauses 1-18, wherein the plurality of interconnected struts comprise a thickness of 2 millimeters or less.

Example Clause 20: The insulative baffle of any one of Example Clauses 1-19, wherein the plurality of interconnected struts comprise a thickness of 1 millimeter or less.

Example Clause 21: The insulative baffle of any one of Example Clauses 1-20, wherein the plurality of interconnected struts comprise a thickness of 0.8 millimeters or less.

Example Clause 22: The insulative baffle of any one of Example Clauses 1-21, wherein the plurality of interconnected struts comprise a thickness of 0.7 millimeters or less.

Example Clause 23: The insulative baffle of any one of Example Clauses 1-22, wherein the plurality of interconnected struts comprise a thickness of 0.6 millimeters or less.

Example Clause 24: The insulative baffle of any one of Example Clauses 1-23, wherein each of the plurality of interconnected struts comprise two ends, and wherein each end connects an associated strut with one or two other struts.

Example Clause 25: The insulative baffle of any one of Example Clauses 1-24, wherein at least one of the plurality of insulative 3D structures comprise an icosahedron shape.

Example Clause 26: The insulative baffle of any one of Example Clauses 1-25, wherein at least one of the plurality of insulative 3D structures comprise a truncated icosahedron shape.

Example Clause 27: The insulative baffle of any one of Example Clauses 1-26, wherein at least one of the plurality of insulative 3D structures comprise a buckminsterfullerene shape.

Example Clause 28: An insulative three-dimensional (3D) structure comprising: a plurality of interconnected struts defining a frame of the insulative 3D structure; a plurality of apertures defined between the struts; wherein the frame forms a unitary body that defines a cavity within the frame; and wherein the insulative 3D structure is configured to provide resilient structure to a baffle, and wherein the insulative 3D structure is configured to facilitate an insulative quality of the baffle.

Example Clause 29: The insulative 3D structure of Example Clause 28, wherein each of the plurality of apertures comprise a shape based on the plurality of interconnected struts defining an associated aperture, and wherein each of the shapes is either a hexagonal shape or a pentagonal shape.

Example Clause 30: The insulative 3D structure of Example Clause 28 or Example Clause 29, further comprising: twenty hexagonal-shaped apertures; and twelve pentagonal-shaped apertures.

Example Clause 31: The insulative 3D structure of any one of Example Clauses 28-30, wherein at least one side of at least one shape is defined by a space between interconnecting struts.

Example Clause 32: The insulative 3D structure of any one of Example Clauses 28-31, wherein at least one aperture comprises a planar shape.

Example Clause 33: The insulative 3D structure of any one of Example Clauses 28-32, wherein the planar shape comprises a circle.

Example Clause 34: The insulative 3D structure of any one of Example Clauses 28-33, wherein the planar shape comprises a semi-circle.

Example Clause 35: The insulative 3D structure of any one of Example Clauses 28-34, wherein the planar shape comprises an oval.

Example Clause 36: The insulative 3D structure of any one of Example Clauses 28-35, wherein the planar shape comprises an arc.

Example Clause 37: The insulative 3D structure of any one of Example Clauses 28-36, wherein the plurality of interconnected struts comprises sixty points where at least two of the plurality of interconnected struts connect.

Example Clause 38: The insulative 3D structure of any one of Example Clauses 28-37, wherein the plurality of interconnected struts comprises twenty points where at least two of the plurality of interconnected struts connect.

Example Clause 39: The insulative 3D structure of any one of Example Clauses 28-38, comprising a diameter defined by a longest distance between points where struts connect.

Example Clause 40: The insulative 3D structure of any one of Example Clauses 28-39, wherein the diameter is 26 millimeters or less.

Example Clause 41: The insulative 3D structure of any one of Example Clauses 28-40, wherein the diameter is 19 millimeters or less.

Example Clause 42: The insulative 3D structure of any one of Example Clauses 28-41, wherein the diameter is 2 inches or less.

Example Clause 43: The insulative 3D structure of any one of Example Clauses 28-42, wherein the diameter is 0.75 inches or less.

Example Clause 44: The insulative 3D structure of any one of Example Clauses 28-43, wherein the diameter of the insulative 3D structure is 0.625 inches or less.

Example Clause 45: The insulative 3D structure of any one of Example Clauses 28-44, wherein the diameter of the insulative 3D structure is 0.5 inches or less.

Example Clause 46: The insulative 3D structure of any one of Example Clauses 28-45, wherein the struts comprise a thickness of 2 millimeters or less.

Example Clause 47: The insulative 3D structure of any one of Example Clauses 28-46, wherein the struts comprise a thickness of 1 millimeter or less.

Example Clause 48: The insulative 3D structure of any one of Example Clauses 28-47, wherein the struts comprise a thickness of 0.8 millimeters or less.

Example Clause 49: The insulative 3D structure of any one of Example Clauses 28-48, wherein the struts comprise a thickness of 0.7 millimeters or less.

Example Clause 50: The insulative 3D structure of any one of Example Clauses 28-49, wherein the struts comprise a thickness of 0.6 millimeters or less.

Example Clause 51: The insulative 3D structure of any one of Example Clauses 28-50, wherein each of the struts comprises two ends, and wherein each end connects an associated strut with one or two other struts.

Example Clause 52: The insulative 3D structure of any one of Example Clauses 28-51, wherein at least one of the insulative 3D structures comprise an icosahedron shape.

Example Clause 53: The insulative 3D structure of any one of Example Clauses 28-52, wherein at least one of the insulative 3D structures comprise a truncated icosahedron shape.

Example Clause 54: The insulative 3D structure of any one of Example Clauses 28-53, wherein at least one of the insulative 3D structures comprise a buckminsterfullerene shape.

Example Clause 55: A method of manufacturing the insulative 3D structure of any one of Example Clauses 28-54.

Example Clause 56: An insulative article comprising: a shell material; a liner material spaced from the shell material to define at least one baffle; and a sheet disposed within the at least one baffle, the sheet comprising a plurality of insulative three-dimensional (3D) structures interconnected by a plurality of interconnecting struts, wherein at least two of the plurality of interconnecting struts meet at, or are integral with, at least one connector region positioned between adjacent at least one of the plurality of insulative 3D structures, wherein the sheet is attached to at least one of the shell material and the liner material at the at least one connector region, and wherein a majority of the plurality of insulative 3D structures is free of direct attachment to the shell material and the liner material so as to maintain loft, compressibility, and flexibility of the sheet within the at least one baffle.

Example Clause 57: The insulative article of Example Clause 56, wherein each of the at least one connector region comprises a disk-like, tab-like, or otherwise substantially planar area having a surface area greater than a cross-sectional area of at least one of the interconnecting struts.

Example Clause 58: The insulative article of Example Clause 56 or Example Clause 57, wherein the at least one connector region comprises at least two connector regions, wherein the sheet comprises a repeating pattern of the plurality of insulative 3D structures, and the at least two connector regions are distributed across the sheet at regular or irregular intervals that correspond to the repeating pattern of the plurality of insulative 3D structures.

Example Clause 59: The insulative article of any one of Example Clauses 56-58, wherein the at least one connector region comprises at least two connector regions and wherein at least some of the at least two connector regions are located at intersections of the interconnecting struts.

Example Clause 60: The insulative article of any one of Example Clauses 56-59, wherein the at least one connector region comprises at least two connector regions, and wherein at least some of the at least two connector regions are located in planar regions formed between adjacent insulative 3D structures.

Example Clause 61: The insulative article of any one of Example Clauses 56-60, wherein the at least one connector region comprises at least two connector regions, and wherein at least some of the at least two connector regions comprise through-holes, surface texturing, or other surface features configured to enhance bonding strength or mechanical interlock with at least one of an adhesive, the shell material, and the liner material.

Example Clause 62: The insulative article of any one of Example Clauses 56-61, wherein the sheet is attached to the at least one of the shell material and the liner material at the at least one connector region by stitching extending through the at least one connector region and through the at least one of the shell material and the liner material.

Example Clause 63: The insulative article of any one of Example Clauses 56-62, wherein the stitching is arranged along quilting lines or baffle boundaries formed in at least one of the shell material and the liner material.

Example Clause 64: The insulative article of any one of Example Clauses 56-63, wherein the sheet is attached to the at least one of the shell material and the liner material at the at least one connector region by at least one of: adhesive bonding, thermal bonding, ultrasonic welding, or mechanical fastening.

Example Clause 65: The insulative article of any one of Example Clauses 56-64, wherein the mechanical fastening comprises at least one of snaps or rivets extending through the at least one connector region.

Example Clause 66: The insulative article of any one of Example Clauses 56-65, wherein attachment of the sheet to the at least one of the shell material and the liner material is localized substantially to the at least one connector region so as to reduce stress concentrations at attachment points and reduce a stiff or board-like feel in the insulative article.

Example Clause 67: The insulative article of any one of Example Clauses 56-66, wherein the at least one connect region comprises at least two connector regions, and wherein at least two connector regions are spaced apart such that the sheet is anchored at discrete attachment points while remaining free to drape and articulate between the discrete attachment points, thereby allowing the plurality of insulative 3D structures to expand, compress, and recover between the discrete attachment points.

Example Clause 68: The insulative article of any one of Example Clauses 56-67, wherein the plurality of interconnecting struts and the at least one connector region collectively define a network of openings between adjacent insulative 3D structures, the network of openings configured to permit the sheet to flex and conform to curved or contoured regions of the insulative article.

Example Clause 69: The insulative article of any one of Example Clauses 56-68, wherein the plurality of insulative 3D structures comprise unitary polymeric frames formed by an additive manufacturing process and having one or more internal apertures.

Example Clause 70: The insulative article of any one of Example Clauses 56-69, wherein at least some of the plurality of insulative 3D structures are selected from the group consisting of hollow spheres, truncated spheres, cubic structures, tetrahedral structures, lattice-type structures, and combinations thereof.

Example Clause 71: The insulative article of any one of Example Clauses 56-70, wherein the shell material has an air permeability between about 0.1 cubic feet per minute (cfm) and about 250 cfm, as measured in accordance with a standard textile air-permeability test method.

Example Clause 72: The insulative article of any one of Example Clauses 56-71, wherein the shell material has an air permeability greater than about 50 cfm.

Example Clause 73: The insulative article of any one of Example Clauses 56-72, wherein the shell material has an air permeability greater than about 100 cfm.

Example Clause 74: The insulative article of any one of Example Clauses 56-73, wherein the shell material has an air permeability in a range from about 0.1 cfm to about 50 cfm.

Example Clause 75: The insulative article of any one of Example Clauses 56-74, wherein the combination of the sheet of interconnected insulative 3D structures and the shell material having a recited air permeability provides thermal insulation performance comparable to or greater than that of a down-filled or staple-fiber-filled article using a lower-permeability face fabric, while reducing or eliminating migration of insulation material through the shell material.

Example Clause 76: The insulative article of any one of Example Clauses 56-75, wherein the at least one connector region comprises at least two connector regions, and wherein the at least two connector regions are positioned and spaced to correspond generally to visible quilting lines or seam lines on an exterior surface of the shell material.

Example Clause 77: The insulative article of any one of Example Clauses 56-76, wherein the insulative article is selected from the group consisting of jackets, vests, pants, sleeping bags, quilts, gloves, mittens, footwear, and bedding.

The foregoing disclosure provides illustration and description but is not intended to be exhaustive or to limit the implementations to the precise form disclosed. Modifications may be made in light of the above disclosure or may be acquired from practice of the implementations. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An insulative baffle comprising:
a shell material;
a liner material, wherein the shell material and the liner material define a baffle cavity therebetween; and
a plurality of insulative three-dimensional (3D) structures disposed in the baffle cavity, wherein the plurality of insulative 3D structures comprise a plurality of interconnected struts defining a frame of each of the plurality of insulative 3D structures, wherein a plurality of apertures are further defined between the plurality of interconnected struts, wherein the frame forms a unitary body that defines a cavity within the frame, wherein the plurality of insulative 3D structures are configured to provide resilient structure to the insulative baffle, and wherein the plurality of insulative 3D structures are configured to facilitate an insulative quality of the insulative baffle.

2. The insulative baffle of claim 1, wherein each of the plurality of insulative 3D structures comprise a diameter, wherein the diameter of a particular insulative 3D structure is defined by a longest distance between points on the particular insulative 3D structure where struts connect.

3. The insulative baffle of claim 2, wherein the diameters of the plurality of insulative 3D structures are 26 millimeters or less.

4. The insulative baffle of claim 2, wherein the diameters of the plurality of insulative 3D structures are 19 millimeters or less.

5. The insulative baffle of claim 1, wherein at least one of the plurality of insulative 3D structures comprise a pentagonal dodecahedron shape.

6. The insulative baffle of claim 1, wherein at least one of the plurality of insulative 3D structures comprise a truncated icosahedron shape.

7. The insulative baffle of claim 1, wherein at least one of the plurality of insulative 3D structures comprise a buckminsterfullerene shape.

8. An insulative three-dimensional (3D) structure comprising:
a plurality of interconnected struts defining a frame of the insulative 3D structure;
a plurality of apertures defined between the struts;
wherein the frame forms a unitary body that defines a cavity within the frame; and
wherein the insulative 3D structure is configured to provide resilient structure to a baffle, and wherein the insulative 3D structure is configured to facilitate an insulative quality of the baffle.

9. The insulative 3D structure of claim 8, wherein each of the plurality of apertures comprise a shape based on the plurality of interconnected struts defining an associated aperture.

10. The insulative 3D structure of claim 9, wherein at least one aperture comprises a planar shape.

11. The insulative 3D structure of claim 10, wherein the planar shape comprises a pentagon.

12. The insulative 3D structure of claim 10, wherein the planar shape comprises a hexagon.

13. An insulative article comprising:
one or more of a shell or liner material; and
a sheet disposed adjacent and attached to the one or more of the shell or liner material, the sheet comprising a plurality of insulative three-dimensional (3D) structures interconnected by a plurality of interconnecting struts,
wherein at least two of the plurality of interconnecting struts meet at, or are integral with, at least one connector region positioned between adjacent at least one of the plurality of insulative 3D structures, and
wherein a majority of the plurality of insulative 3D structures is free of direct attachment to the shell material so as to maintain loft, compressibility, and flexibility of the sheet.

14. The insulative article of claim 13, wherein each of the at least one connector region comprises a disk-like, tab-like, or otherwise substantially planar area having a surface area greater than a cross-sectional area of at least one of the interconnecting struts.

15. The insulative article of claim 13, wherein the at least one connector region comprises at least two connector regions, wherein the sheet comprises a repeating pattern of the plurality of insulative 3D structures, and the at least two connector regions are distributed across the sheet at regular or irregular intervals that correspond to the repeating pattern of the plurality of insulative 3D structures.

16. The insulative article of claim 13, wherein the at least one connector region comprises at least two connector regions and wherein at least some of the at least two connector regions are located at intersections of the interconnecting struts.

17. The insulative article of claim 13, wherein the at least one connector region comprises at least two connector regions, and wherein at least some of the at least two connector regions are located in planar regions formed between adjacent insulative 3D structures.

18. The insulative article of claim 13, wherein the sheet is attached to the one or more of the shell or liner material at the at least one connector region.

19. The insulative article of claim 13, wherein the sheet is attached to the one or more of the shell or liner material by at least one of: adhesive bonding, thermal bonding, ultrasonic welding, or mechanical fastening.

20. The insulative article of claim 13, wherein the one or more of the shell or liner material is not down-proof.
